(19) United States
(12) Patent Application Publication
(10) Pub. No.: US 2002/0127394 A1
(43) Pub. Date: Sep. 12, 2002

(54) Advertising arrangement applicable to laminar strips of plastic material for shrink-wrapping and protecting luggage

(76) Inventor: Norberto Chinique Pena, Madrid (ES)

Correspondence Address: ALFRED M. WALKER, 225 OLD COUNTRY ROAD, MELVILLE, NY, 11747-2712, US

(21) Appl. No.: 09/844,810

(22) Filed: Apr. 27, 2001

(30) Foreign Application Priority Data
Apr. 27, 2000 (ES) P. 200001087/3

(51) Int. Cl. B42D 15/00; B42D 15/10; B32B 7/12; B32B 15/04; B41M 3/12

(52) U.S. Cl. 428/343; 428/345; 283/72; 428/914; 428/915; 428/916

(57) ABSTRACT

An advertising arrangement applicable to laminar strips of plastic material for shrink-wrapping and protecting luggage, which consists of incorporating inside the tunnel (3) of a machine for protecting luggage means for positioning labels (5) and (5′) of any shape considered appropriate, provided with means for fixing in the central area of the luggage (9). The labels to be incorporated or the similar means are made up of a spool (6) and (6′) situated in the upper part and tensioned in the lower part by appropriate means (7) and (7′). The luggage (9) exits by means of a conveyor or roller belt

### OBJECT OF THE INVENTION

The present specification refers to a Patent of Invention application relating to an advertising arrangement applicable to laminar strips of plastic material for shrink-wrapping and protecting luggage, whose purpose is to incorporate on the laminar body, positioned on the larger sides of the body of the duly shrink-wrapped and protected luggage, an area showing graphics by conventional means which constitutes the advertising to be incorporated. Said advertising is situated on the sheet prior to the dispatch of the duly protected luggage, this operation being carried out automatically, incorporating advertising about a single subject, two subjects or several subjects. The incorporated advertising occupies the central area of the duly protected luggage.

The arrangement that is the object of the invention may use a plastic sheet with dimensions in accordance with the luggage to be protected, upon which the graphic display in question has been previously incorporated in appropriate areas so that these graphic displays which constitute advertising in general are situated on the surface corresponding to the central area of the larger sides.

### FIELD OF THE INVENTION

The application of this invention is in the industry which manufactures devices for protecting luggage situated in airports, railway stations, bus stations, hotels, etc. It may also be used by the advertising industry in general.

### BACKGROUND OF THE INVENTION

The applicant is aware of the existence of machines for shrink-wrapping and protecting luggage situated at different points, which use a sheet of plastic material of greater or lesser strength for shrink-wrapping and protecting luggage adequately.

The invention uses a sheet of transparent, translucent or opaque plastic material of greater or lesser thickness and, according to the dimensions of the luggage to be protected. Said sheet is attached to the outside of the luggage by mechanical means and at the end of the machine's operation it surrounds and shrink-wraps the luggage in question, generally using a sheet of transparent plastic material in order to enable the owner of the luggage to view and arrange the luggage in question so as to be able to identify it at the collection and transportation points.

It is established that when a continuous sheet is used to shrink-wrap luggage of different shapes and sizes, and although the sheet incorporates advertising texts on its surface, these texts do not, except accidentally, remain centered on the surface of the larger sides, which is the place considered to be most suitable for their display and subsequent announcement of the advertising message. Moreover, the message will not be visible, but displaced from the central area; and, of course, it will not be visible at all if the advertising display areas are shrink-wrapped in such a way that they are situated in the upper or lower part.

In view of what is described above, it is necessary to use a machine to shrink-wrap and protect luggage which uses a sheet of appropriate plastic material, but at the same time, in order to maximise the effectiveness of an advertising message, it is indispensable to apply to the sheet of transparent, translucent or opaque plastic material means which make up an advertising device which situates the graphic display of the advertising message at a point in the shrink-wrapping where it is situated monovalently or polyvalently on the larger sides of the shrink-wrapped luggage, and obviously centered.

However, the applicant is not aware of the existence at the present time of an invention that is provided with the features indicated above as being suitable.

### DESCRIPTION OF THE INVENTION

The advertising arrangement applicable to laminar strips of plastic material for shrink-wrapping and protecting luggage proposed by the invention, is in itself an evident novelty within its field of application, as it allows an advertising message, which may be monovalent or polyvalent and which is properly positioned, to be incorporated on the sides of shrink-wrapped and protected luggage.

More specifically, the advertising arrangement applicable to laminar strips of plastic material for shrink-wrapping and protecting luggage that is the object of the invention is formed by incorporating two parts at the exit of the protective machine which are situated adjacent to the theoretical larger sides in the inner area. On said two parts, by means of a hydraulic piston provided with heating means for electro-welding, an appropriately decorated and silk screen printed label is made, which is fixed to the larger sides of the suitcase in question, remaining stationary and centered.

By means of this operation, the machine can also incorporate a direct silk screen print using appropriate material upon the surface of the luggage.

### DESCRIPTION OF THE DRAWINGS

To complement the description that is being given and in order to promote a better understanding of the features of the invention, the present specification is accompanied, as an integral part of the same, by a sheet of drawings in which, by way of illustration and non-restrictively, the following is represented:

FIG. 1 is a side elevation view of a machine or device for protecting luggage in airports, railway stations, bus stations, ports and hotels, inside which the object of the invention is incorporated, which relates to an advertising arrangement applicable to laminar strips of plastic material, for shrink-wrapping and protecting luggage.

FIG. 2 shows a front elevation of the object represented in FIG. 1, through whose operating mouth the elements comprising the object of the invention can be seen.

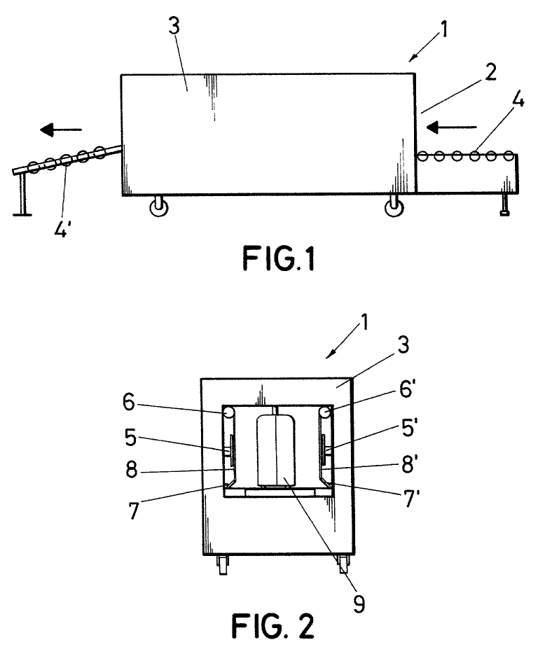

### PREFERRED EMBODIMENT OF THE INVENTION

In the light of these drawings, it may be observed that the proposed advertising arrangement applicable to laminar strips of plastic material for shrink-wrapping and protecting luggage is made up of a machine for protecting luggage (1) by shrink-wrapping, which uses sheets of plastic material to protect the suitcases or the like, which enter through the opening (2) by means of a conveyor belt (4) that incorporates them inside the tunnel (3), in which all the appropriate elements are situated for carrying out the relevant shrink-wrapping and protection of the luggage. The latter exit duly protected, by means of the conveyor belt or roller belt (4′).

Close to the exit of the body (3) in front of the entrance (2) two pistons (5) and (5′) are situated, which are operated by conventional means, provided with electro-welding means and photo-sensitive cells, to appropriately position the advertising which is displayed on a label or conveyor strip (8) and (8′). These labels, silk screen prints or the like will be positioned on the larger sides of the suitcase (9). The conveyor strip of the labels is situated on spools (6) and (6′), which are tensed in their lower part by conventional means (7) and (7′). Therefore, once the duly shrink-wrapped suitcase is situated in front of the positioning elements (5) and (5′), these position the elements (5) and (5′) at an appropriate height according to the photo-sensitive cells and then approach the sides of the duly covered suitcase (9), incorporating the label on the central area by means of thermal bonding; or the elements (5) and (5′) act as conventional silk screen elements which transfer the image to the covered sides of the body of the suitcase (9).

Once the suitcase (9) has left the body (3) by means of the roller track (4′), the luggage situated there subsequently will be similarly treated and the elements (5) and (5′) duly positioned in its central area according to the luggage's specific size.

It must be pointed out that the invention is able to prevent the operation of the positioning elements (5) and (5′) of the labels or sheets (8) and (8′), if their dimensions or contours do not allow it.

The invention allows the operation to take place on suitcases that are shrink-wrapped and protected by sheets of transparent, opaque or translucent plastic material.

It must also be pointed out that, as an option, labels of previously printed paper may be incorporated which, together with self-adhesive that can be crystallised by heat, are fixed to the surface of the plastic which carries out the shrink-wrapping and protection of the suitcase (9).

As we stated above, this invention may incorporate shrink-wrapping sheets that incorporate the advertising image applicable to standard luggage dimensions, using the conventional shrink-wrapping spool when the suitcases to be treated and protected are not of the appropriate dimensions.

Logically, the invention may operate by using bags of plastic material with dimensions that are appropriate to the volume of the luggage to be protected, the advertising having been previously applied to said bags, occupying a rectangular space in a single advertising presentation or multiple presentations.

In accordance with the structure described in the foregoing paragraph and in the characteristics of this invention, it may be stated that the invention may use two spools for pre-shrinking, which have been previously provided with an advertising image on the same. The operation of wrapping the luggage itself with plastic from the spools is carried out, and then shrink-wrapping takes place in the heat tunnel.

To summarise this optional embodiment, the advertising may be done by using spools that are spliced together and provided with previously printed advertising, thus achieving the use of a sheet which envelops the suitcase or luggage, which is shrink-wrapped by means of a conventional heating system. This has the advantage of achieving spools that are previously provided with advertising, spliced together and previously printed, with which the suitcase is wrapped.

It is not considered necessary to prolong this description so that any expert in the subject can understand the scope of the invention and the advantages arising from the same.

The materials, shape, size and arrangement of the elements may be varied, provided that this does not mean any alteration to the essential nature of the invention.

The terms in which this report has been drawn up are to be taken always in their broad and non-restrictive sense.

1. An advertising arrangement applicable to laminar strips of plastic material for shrink-wrapping and protecting luggage, comprising a shrink-wrap applicator incorporated inside a tunnel (3) of a machine for protecting luggage (1) by means of a sheet of plastic material, which said sheet of plastic material wraps and protects a suitcase (9), said suitcase (9) having a pair of larger size side panels joined by smaller front, rear, top and bottom portions, said shrink-wrap applicator using at least one sheet of plastic material, which said at least one sheet of plastic material enters said tunnel (3) by means of a leading carrier (4) through an entrance (2) of said tunnel (3); said tunnel having, at points close to an exit carrier (4′), said shrink-wrap applicator for fixing visible indicia by appropriate attachment means to at least one larger size side panel of said body of said suitcase (9), which said suitcase (9) has previously been shrink-wrapped and protected by said at least one plastic sheet; said shrink-wrap applicator having at least one fixing element (5), (5′) have heating means for fixing said visual indicia obtained from said sheet of plastic material(8) and (8′), said sheet of plastic material (8) and (8′) being incorporated on spools (6) and (6′) and being held in place by tensors (7) and (7′) situated in a lower part of said shrink-wrap applicator; said fixing elements (5), (5′) moving by at least one actuator.

2. An advertising arrangement applicable to laminar strips of plastic material for shrink-wrapping and protecting luggage, as claimed in claim 1, wherein said means for fixing advertising labels (8) and (8′) which incorporate graphic displays with a single subject or with many subjects, have a photo-sensitive cell for the locating or situating of the label in the central area of the covering of the suitcase (9).

3. An advertising arrangement applicable to laminar strips of plastic material for shrink-wrapping and protecting luggage, as claimed in claim 1, wherein said fixing elements (5) and (5′), which position said visible indicia on said suitcase (9) shrink-wrap covering, are provided with stopping means when said suitcase (9), upon which the labels are to be fixed on its two sides, has an irregular contour.

4. An advertising arrangement applicable to laminar strips of plastic material for shrink-wrapping and protecting luggage, as claimed in claim 1, wherein said fixing elements (5) and (5′) may be replaced by means of direct silk-screening onto the protective sheet of the suitcase (9).

5. An advertising arrangement applicable to laminar strips of plastic material for shrink-wrapping and protecting luggage, as claimed in claim 4, wherein said fixing elements (5) and (5′) may be replaced by means of fixing labels with adhesive that can be crystallized by heat.

6. An advertising arrangement applicable to laminar strips of plastic material for shrink-wrapping and protecting luggage, as claimed in claim 1, wherein said fixing elements (5) and (5′) may be replaced by appropriate means for fixing said visible indicia by wetting.

7. An advertising arrangement applicable to laminar strips of plastic material for shrink-wrapping and protecting luggage, as claimed in claim 1, wherein said visible indicia may be incorporated previously on a covering of plastic material for protecting said suitcase, said covering being provided with different sizes and the incorporated visible indicia occupying a single area of application.

8. An advertising arrangement applicable to laminar strips of plastic material for shrink-wrapping and protecting luggage, as claimed in claim 1, wherein said visible indicia may be incorporated previously on a covering of plastic material for protecting said suitcase, said covering being provided with different sizes and the incorporated visible indicia occupying multiple areas of application.

9. An advertising arrangement applicable to laminar strips of plastic material for shrink-wrapping and protecting luggage, as claimed in claim 1, wherein said shrink-wrapping of said suitcase may be carried out from a plurality of spools of plastic material joined together, said spools being provided with the previously printed advertising.

10. An advertising arrangement as in claim 1 wherein said plastic sheet is transparent plastic material.

11. An advertising arrangement as in claim 1 wherein said plastic sheet is opaque plastic material.

12. An advertising arrangement as in claim 1 wherein said plastic sheet is translucent plastic material.

13. An advertising arrangement as in claim 1 wherein said carrier is a conveyor belt.

14. An advertising arrangement as in claim 1 wherein said carrier is a conveyor ramp.

15. An advertising arrangement as in claim 1 wherein said carrier is a roller.

16. An advertising arrangement as in claim 1 wherein said visible indicia is a label.

17. An advertising arrangement as in claim 1 wherein said visible indicia is an image.

18. An advertising arrangement as in claim 1 wherein said visible indicia is an advertising message.

19. An advertising arrangement as in claim 1 wherein said actuator is hydraulic.

20. An advertising arrangement as in claim 1 wherein said actuator is pneumatic.
